(19) United States
(12) Patent Application Publication
(10) Pub. No.: US 2024/0361574 A1
(43) Pub. Date: Oct. 31, 2024

(54) LOW THERMAL-DRIFT OPTICAL LENS

(71) Applicant: Young Optics Inc., Hsinchu Science Park (TW)

(72) Inventors: Ching-Sheng CHANG, Hsinchu Science Park (TW); Chia-Chen KUNG, Hsinchu Science Park (TW); Chiu-Jung LAI, Hsinchu Science Park (TW); Kuo-Chuan WANG, Hsinchu Science Park (TW)

(21) Appl. No.: 18/763,511

(22) Filed: Jul. 3, 2024

Related U.S. Application Data
(63) Continuation of application No. 16/909,224, filed on Jun. 23, 2020.

(30) Foreign Application Priority Data
Jul. 5, 2019 (TW) 108123868

(51) Int. Cl. G02B 13/00; G02B 9/10

(52) U.S. Cl. CPC G02B 13/003; G02B 9/10

(57) ABSTRACT

A low thermal-drift optical lens includes a first lens group, a second lens group and an aperture stop. The first lens group includes a first lens and a second lens, and the second lens group includes a third lens and a cemented lens. The aperture stop is disposed between the second lens and the cemented lens, and a lens with a refractive power of the low thermal-drift optical lens closest to the minified side has at least one inflection point. In an operating temperature range of −40° C. to 80° C., a thermal drift of the low thermal-drift optical lens relative to a focal plane at 25° C. is less than or equal to 10 um.

### CROSS-REFERENCE TO RELATED APPLICATIONS

This application is a continuation application of application Ser. No. 16/909,224 filed Jun. 23, 2020, the contents of which are incorporated by reference herein.

### BACKGROUND OF THE INVENTION

### a. Field of the Invention

The invention relates to a low thermal-drift optical lens.

### p b. Description of the Related Art

Recent advances in technology have led to the development of various types of imaging lenses. For example, an image pick-up lens used in smart-home appliances, access controls, surveillance cameras, in-vehicle cameras or action cameras is a commonly used optical lens. Nowadays, there is a growing need for the image pick-up lens to be miniaturized and have high optical performance. To meet these requirements, the optical lens needs to have, for example, low fabrication costs, high resolution, large effective aperture, wide viewing angles, low thermal drift, 24-hours confocal image-capturing capability, a short total track length, a long back focus, and a miniaturized layout. Therefore, it is desirable to provide an imaging lens that may achieve lower fabrication costs, wider viewing angles, lower thermal drift, a shorter total track length, a longer back focus, a miniaturized layout, 24-hours confocal image-capturing capability and better imaging quality.

### BRIEF SUMMARY OF THE INVENTION

According to one aspect of the present disclosure, a low thermal-drift optical lens includes a first lens group, a second lens group and an aperture stop. The first lens group and the second lens group are arranged in order from a magnified side to a minified side. The first lens group includes a first lens and a second lens, the second lens group includes a third lens and a cemented lens, and at least one of the second lens and the third lens is an aspheric plastic lens. A lens with a refractive power of the low thermal-drift optical lens closest to the minified side has at least one inflection point. A total number of lenses with refractive powers in the low thermal-drift optical lens is less than eight, and the low thermal-drift optical lens includes at most three aspheric lenses. In an operating temperature range of −40° C. to 80° C., a thermal drift of the low thermal-drift optical lens relative to a focal plane at 25° C. is less than or equal to 10 um.

According to another aspect of the present disclosure, a low thermal-drift optical lens includes a first lens group, a second lens group and an aperture stop. The first lens group and the second lens group are arranged in order from a magnified side to a minified side. The first lens group includes a first lens and a second lens, the second lens group includes a third lens and a cemented lens, and at least one of the second lens and the third lens is an aspheric plastic lens. An aperture stop is disposed between the second lens and the cemented lens. A total number of lenses with refractive powers in the low thermal-drift optical lens is less than eight, and the low thermal-drift optical lens includes at most three aspheric lenses. The low thermal-drift optical lens satisfies the condition: 1.4<OAL/IM<1.9, where OAL denotes a distance between two outermost lens surfaces among all lenses of the low thermal-drift optical lens measured along the optical axis, and IM denotes an image circle diameter measured on a visible-light focal plane of the low thermal-drift optical lens.

According to the above aspects, the low thermal-drift optical lens may achieve at least one of the following advantage: lower fabrication costs, wider viewing angles, lower thermal drift, high resolution, a large effective aperture, a miniaturized layout, a shorter total track length, a longer back focus, 24-hours confocal image-capturing capability and better imaging quality. Besides, according to the above embodiments, a total number of lenses with refractive powers in the optical lens is 5-7, and the overall lens length OAL, namely a distance between two outermost lens surfaces among all lenses of the optical lens measured along the optical axis, is smaller than 11 mm.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a cross-sectional illustration of an optical lens according to an embodiment of the invention.

FIG. 2, FIG. 3, FIG. 4 and FIG. 5 respectively show a ray fan plot for visible light, a ray fan plot for infrared light, a relative illumination plot, and an astigmatic field curve/a percentage distortion curve of the optical lens shown in FIG. 1.

FIG. 6 shows a cross-sectional illustration of an optical lens according to another embodiment of the invention.

FIG. 7, FIG. 8, FIG. 9 and FIG. 10 respectively show a ray fan plot for visible light, a ray fan plot for infrared light, a relative illumination plot, and an astigmatic field curve/a percentage distortion curve of the optical lens shown in FIG. 6.

FIG. 11 shows a cross-sectional illustration of an optical lens according to another embodiment of the invention.

FIG. 12, FIG. 13, FIG. 14 and FIG. 15 respectively show a ray fan plot for visible light, a ray fan plot for infrared light, a relative illumination plot, and an astigmatic field curve/a percentage distortion curve of the optical lens shown in FIG. 11.

FIG. 16 shows a cross-sectional illustration of an optical lens according to another embodiment of the invention.

FIG. 17, FIG. 18, FIG. 19 and FIG. 20 respectively show a ray fan plot for visible light, a ray fan plot for infrared light, a relative illumination plot, and an astigmatic field curve/a percentage distortion curve of the optical lens shown in FIG. 16.

FIG. 21 shows a cross-sectional illustration of an optical lens according to another embodiment of the invention.

FIG. 22, FIG. 23, FIG. 24 and FIG. 25 respectively show a ray fan plot for visible light, a ray fan plot for infrared light, a relative illumination plot, and an astigmatic field curve/a percentage distortion curve of the optical lens shown in FIG. 21.

FIG. 26 shows a cross-sectional illustration of an optical lens according to another embodiment of the invention.

FIG. 27, FIG. 28, FIG. 29 and FIG. 30 respectively show a ray fan plot for visible light, a ray fan plot for infrared light, a relative illumination plot, and an astigmatic field curve/a percentage distortion curve of the optical lens shown in FIG. 26.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc, as used herein, are used as labels for nouns that they precede, and do not imply any type of ordering (e.g., spatial, temporal, logical, etc.). The following embodiments of a zoom lens may be applied to any system or environment according to actual demands.

The term “optical element” refers to an element made from at least in part a material that may refract, reflect, diffract, diffuse or filter at least a portion of the light passing through it. The material may include plastic or glass, and the optical element may be, for example, a lens, a prism or an aperture stop.

In an imaging system, a magnified side may refer to one side of an optical path of an imaging lens comparatively near a subject to be picked-up, and a minified side may refer to other side of the optical path comparatively near a photosensor.

A certain region of an object side surface (or an image side surface) of a lens may be convex or concave. Herein, a convex or concave region is more outwardly convex or inwardly concave in the direction of an optical axis as compared with other neighboring regions of the object/image side surface

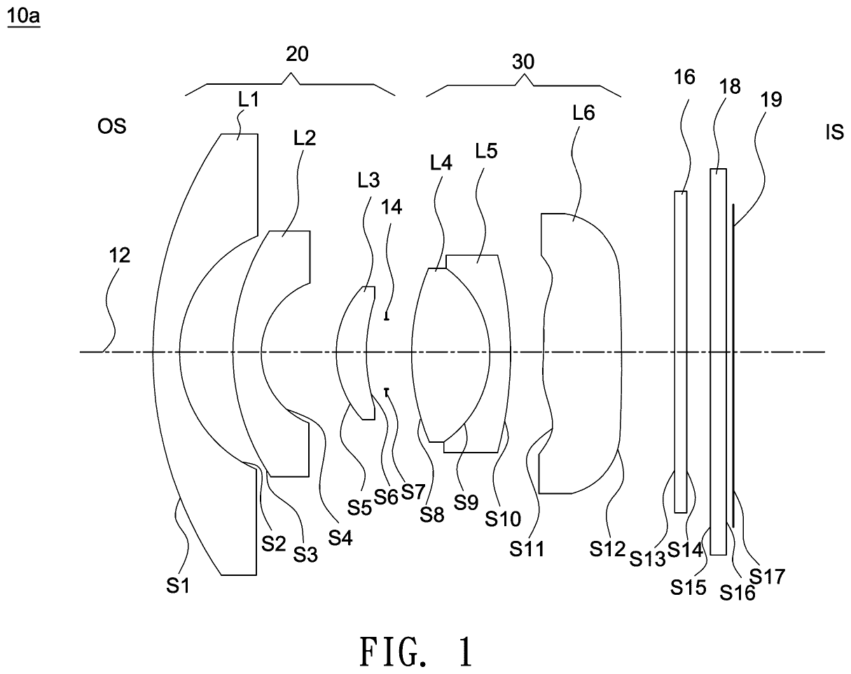

FIG. 1 shows a cross-sectional illustration of an optical lens according to a first embodiment of the invention. As shown in FIG. 1, in this embodiment, the optical lens 10a has a lens barrel (not shown), and inside the lens barrel a first lens L1, a second lens L2, a third lens L3, an aperture stop 14, a fourth lens LA, a fifth lens L5 and a sixth lens L6 are arranged in order from a first side (magnified side OS) to a second side (minified side IS). The first lens L1, the second lens L2 and the third lens L3 form a first lens group 20 (such as a front lens group) with a negative refractive power, and the fourth lens L4, the fifth lens L5 and the sixth lens L6 form a second lens group 30 (such as a rear lens group) with a positive refractive power. Further, the minified side IS is disposed with a light filter 16, a cover glass 18 and a photosensor (not shown), an image plane of the optical lens 10a formed at an effective focal length for visible light is labeled as 19, and the light filter 16 and the cover glass 18 are disposed between the second lens group 30 and the image plane 19 for visible light. In this embodiment, the first lens L1, the second lens L2, the third lens L3, the fourth lens L4, the fifth lens L5 and the sixth lens L6 have negative, negative, positive, positive, negative and positive refractive powers, respectively, and the second lens L2, the third lens L3 and the sixth lens L6 are aspheric plastic lenses. In other embodiment, the aspheric plastic lens may be replaced with an aspheric glass lens. Further, adjoining surfaces of each two adjacent lenses may have an identical radius of curvature or a similar radius of curvature (a radius difference smaller than 0.005 mm) to form a compound lens (such as a cemented lens, a doublet lens, a triplet lens or even higher number lens configurations). In this embodiment, the fourth lens L4 and the fifth lens L5 are fit together to form a cemented doublet, but the invention is not limited thereto. Further, in each of the following embodiments, the magnified side OS is located on the left side and the minified side IS is located on the right side of each figure, and thus this is not repeatedly described in the following for brevity.

The aperture stop 14 is an independent component or integrally formed with other optical element. In this embodiment, the aperture stop may use a mechanic piece to block out peripheral light and transmit central light to achieve aperture effects. The mechanic piece may be adjusted by varying its position, shape or transmittance. In other embodiment, the aperture stop may be formed by applying an opaque or a light-absorbing material on a lens surface except for a central area to block out peripheral light and transmits central light.

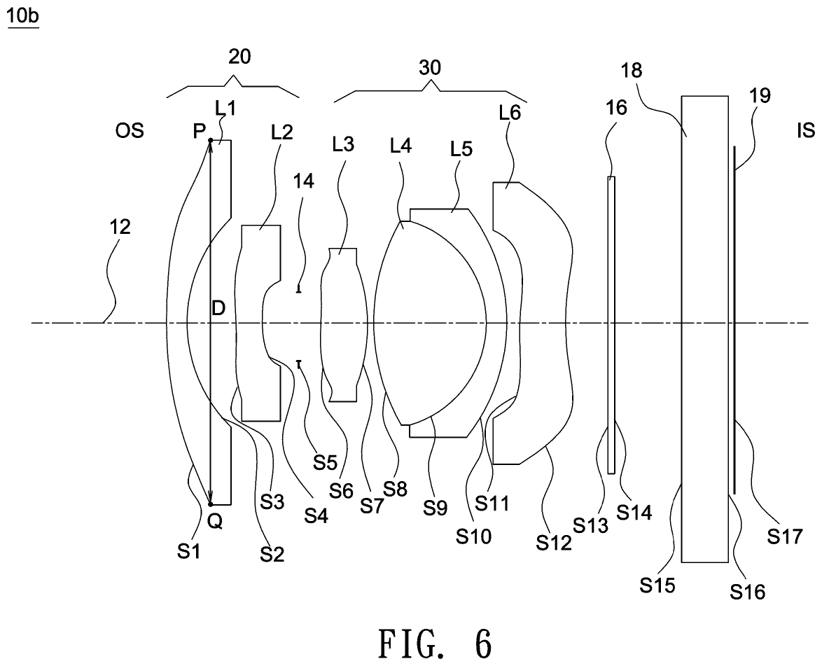

Each lens may be assigned a parameter of “lens diameter”. Taking the lens L1 as an example, the magnified-side surface of the lens L1 has two opposite turning points that are spaced at a first distance measured in a direction perpendicular to the optical axis 12, and the minified-side surface of the lens L1 also has two opposite turning points that are spaced at a second distance measured in a direction perpendicular to the optical axis 12, and the “lens diameter” of the lens L1 is the greater one among the first distance and the second distance. For example, as shown in FIG. 6, two opposite turning points P and Q of the magnified-side surface of the lens L1 forms a greater distance measured in a direction perpendicular to the optical axis 12 as compared with two turning points of the minified-side surface, and thus the distance of the turning points P and Q of the lens L1 in a direction perpendicular to the optical axis 12 is referred to as the “lens diameter” of the lens L1. In the embodiment shown in FIG. 1, a diameter D1 of the lens L1 is 9.60 mm, and a diameter DL of the lens L6 is 5.71 mm.

A spherical lens indicates its front lens surface and rear lens surface are each a part surface of a sphere having a fixed radius of curvature. In comparison, an aspheric lens indicates at least one of its front lens surface and rear lens surface has a radius of curvature that varies along a center axis to correct abbreviations.

Detailed optical data, design parameters and aspheric coefficients of the optical lens 10a are shown in Tables 1 and 2 below. In the following design examples of the invention, each aspheric surface satisfies the following equation:

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + … ,$$

reciprocal of a radius of an osculating sphere, K denotes a Conic constant, r denotes a height of the aspheric surface measured in a direction perpendicular to the optical axis 12, and parameters A-F shown in Table 2 are 4th, 6th, 8th, 10th, 12th and 14th order aspheric coefficients. Note the data provided below are not used for limiting the invention, and those skilled in the art may suitably modify parameters or settings of the following embodiment with reference of the invention without departing from the scope or spirit of the invention.

TABLE 1
F/# = 2.0; EFL = 1.97(mm); TTL = 13.0(mm)
OAL = 10.2(mm); FOV = 184 degrees; D1/OAL = 0.94
D1/IM = 1.45; IM = 6.61(mm)

| | Radius | Interval | Refractive | Abbe | Object |
|---|---|---|---|---|---|
| Surface | (mm) | (mm) | index | number | description |
| S1 | 9.149 | 0.500 | 1.804 | 46.503 | L1(meniscus) |
| S2 | 2.763 | 1.177 | | | |
| S3* | 4.344 | 0.603 | 1.546 | 56.090 | L2(aspheric) |
| S4* | 1.559 | 1.714 | | | |
| S5* | 3.363 | 0.636 | 1.656 | 21.490 | L3(aspheric) |
| S6* | 14.149 | 0.335 | | | |
| S7 | INF. | 0.582 | | | aperture stop 14 |
| S8 | 5.024 | 1.770 | 1.804 | 46.503 | L4(biconvex) |
| S9 | −2.400 | 0.420 | 1.986 | 16.484 | L5(meniscus) |
| S10 | −8.262 | 0.708 | | | |
| S11* | 4.806 | 1.754 | 1.536 | 56.070 | L6(aspheric) |
| S12* | −21.908 | 1.140 | | | |
| S13 | INF. | 0.210 | 1.517 | 64.167 | light filter 16 |
| S14 | INF. | 1.000 | | | |
| S15 | INF. | 0.400 | 1.517 | 64.167 | cover glass 18 |
| S16 | INF. | 0.050 | | | |
| S17 | | | | | image plane 19 |

In the above Table 1, an interval of the surface S1 is a distance between the surface S1 and the surface S2 along the optical axis 12, an interval of the surface S2 is a distance between the surface S2 and the surface S3 along the optical axis 12, and an interval of the surface S16 is a distance between the surface S16 and the image plane 19 along the optical axis 12.

TABLE 2

| | S3 | S4 | S5 | S6 | S11 | S12 |
|---|---|---|---|---|---|---|
| K | −8.22E−01 | −2.40E−01 | 3.21E−01 | 0 | −2.45E+01 | 0 |
| A | 9.64E−03 | 1.47E−02 | 7.10E−03 | 7.65E− | 1.49E−02 | 8.68E− |
| | | | | 03 | | 03 |
| B | −2.39E−03 | −3.61E−03 | 1.04E−02 | 6.62E− | −9.65E−03 | −2.79E− |
| | | | | 03 | | 03 |
| C | 1.04E−04 | −2.18E−04 | −5.63E−03 | −3.67E− | 1.90E−03 | 1.12E− |
| | | | | 03 | | 04 |
| D | 4.30E−06 | −2.78E−04 | 3.09E−03 | 4.08E− | −2.47E−04 | −4.53E− |
| | | | | 03 | | 06 |

In the above table 1, the surface denoted by an asterisk is an aspheric surface, and a surface without the denotation of an asterisk is a spherical surface.

The radius of curvature is a reciprocal of the curvature. When a lens surface has a positive radius of curvature, the center of the lens surface is located towards the minified side. When a lens surface has a negative radius of curvature, the center of the lens surface is located towards the magnified side. The concavity and convexity of each lens surface is listed in each table and shown in corresponding figures.

The Symbol F/# shown in the above table is an F-number of the aperture stop. When the imaging lens is used in an image pick-up system, the image plane is a sensing surface of a photosensor. In one embodiment, an F-number of the optical lens is smaller than or equal to 2.4.

The parameter IM shown in the above table denotes an image height that is equal to an image circle diameter on an image plane of an image pick-up system.

An overall lens length of the optical lens 10a is denoted as “OAL” in the above table. Specifically, the overall lens length OAL is a distance measured along the optical axis 12 between a lens surface S1 closest to the magnified side and a lens surface S12 closest to the minified side (minified-side surface of the lens L6); that is, a distance between two outermost lens surfaces among all lenses of the optical lens measured along the optical axis. In one embodiment, the overall lens length OAL of an optical lens is smaller than 11 mm. Besides, a total track length of the optical lens 10a is denoted as “TTL” in the above table. Specifically, the total track length TTL is a distance along the optical axis 12 between a lens surface S1 closest to the magnified side and the image plane S19. In one embodiment, the total track length TTL of an optical lens is smaller than 14 mm.

In this embodiment, the parameter FOV denoted in the above table is a light collection angle of the optical surface SI closest to the magnified side; that is, the FOV is a full field of view measured diagonally. In one embodiment, the FOV is greater than or equal to 150 degrees.

In one embodiment, the optical lens may include two lens groups, and the front lens group may include two lenses having negative refractive powers, with one of the two negative lenses being an aspheric lens, to enhance light collection capability and achieve a wide field of view. In one embodiment, an F-number of the optical lens is greater than or equal to about 2.0. The rear lens group may have at least one an aspheric lens and a compound lens (such as a cemented lens or a doublet lens) to correct monochromatic and chromatic aberrations, and a minimum distance between two lenses of a doublet lens along an optical axis is smaller than 0.01 mm. The doublet lens may be replaced with a triplet lens without limitation. Adjoining surfaces of each two adjacent lenses of the doublet lens, triplet lens or even higher number lens configurations may have an identical or a similar radius of curvature. A total number of lenses with refractive powers in the optical lens is 5-7. The optical lens may have at least two lenses each with an Abbe number of greater than 50. The cemented lens in the rear group may include at least one lens with an Abbe number of greater than 45 and include at least one lens with an Abbe number of smaller than 20. In one embodiment, a refractive index variation as a function of temperature (dn/dt) of a plastic lens is smaller than −80E−06, where dn denotes a variation in the refractive index of a plastic lens at a temperature variation dt of the plastic lens. By matching the coefficients dn/dt for plastic and glass lenses in an optical lens, a focus shift relative to a focal plane at 25 degrees, namely the thermal drift, is less than or equal to 10 um. The optical lens according to various embodiments of the invention is allowed to operate in the range of −40° C. to 80° C. and can be applied to a 24-hours confocal image-capturing system where a displacement between a focal plane for infrared light (850 nm) and a focal plane for visible light (550 nm) is no more than 10 um.

In one embodiment, the optical lens may satisfy a condition of 0.5<D1/OAL<1.1, a further condition of 0.55<D1/OAL<1.05, and a still further condition of 0.6<D1/OAL<1.0, where D1 is a lens diameter of the first lens L1 closest to the magnified side OS, and OAL denotes an overall lens length that is a distance measured along the optical axis 12 between an optical surface closest to the magnified side (such as the magnified-side surface of the lens L1) and an optical surface closest to the minified side (such as the minified-side surface of the lens L6). Meeting the above conditions may facilitate light converging capability of lenses to reduce the scope of image beams passing through lenses to match the size of a photosensor and thus allow for better optical performance in a limited space.

In one embodiment, the optical lens may satisfy a condition of 0.9<D1/IM<1.6, a further condition of 0.95<D1/IM<1.55, and a still further condition of 1.0<D1/IM<1.5, where IM denotes an image circle diameter measured on a visible-light focal plane of the optical lens, and D1 is a lens diameter of the first lens L1 closest to the magnified side OS. Meeting the above conditions may provide an optimized design of an image sensor matched to the outer diameter of the optical lens.

In one embodiment, the optical lens may satisfy a condition of 1.4<OAL/IM<1.9, a further condition of 1.45<OAL/IM<1.85, and a still further condition of 1.5<OAL/IM<1.8, where IM denotes an image circle diameter measured on a visible-light focal plane of the optical lens and OAL is an overall lens length that is a distance along the optical axis 12 between an optical surface closest to the magnified side and an optical surface closest to the minified side. Note that this criterion allows for an optimized proportion of a photosensor to the overall lens length OAL; that is, providing a proportionally longer OAL when using a larger photosensor and a proportionally shorter OAL when using a smaller photosensor.

FIG. 6 shows a cross-sectional illustration of an optical lens 10b according to a second embodiment of the invention. As shown in FIG. 6, in this embodiment, the optical lens 10b includes a first lens L1, a second lens L2, an aperture stop 14, a third lens L3, a fourth lens LA, a fifth lens L5 and a sixth lens L6. The first lens L1 and the second lens L2 form a first lens group 20 (such as a front lens group) with a negative refractive power, and the third lens L3, the fourth lens L4, the fifth lens L5 and the sixth lens L6 form a second lens group 30 (such as a rear lens group) with a positive refractive power. In this embodiment, the first lens L1, the second lens L2, the third lens L3, the fourth lens L4, the fifth lens L5 and the sixth lens L6 have negative, negative, positive, positive, negative and negative refractive powers, respectively, and the second lens L2, the third lens L3 and the sixth lens L6 are aspheric plastic lenses. In other embodiment, the aspheric plastic lens may be replaced with an aspheric glass lens. Further, the fourth lens L4 and the fifth lens L5 are fit together to form a cemented doublet. In this embodiment, a diameter D1 of the surface S1 is 8.70 mm, and a diameter DL of the surface S12 is 6.15 mm. Detailed optical data and design parameters of the optical lens 10b are shown in Table 3 below.

TABLE 3
F/# = 2.0; EFL = 2.39(mm); TTL = 12.99(mm)
OAL = 9.99(mm); FOV = 182 degrees; D1/OAL = 0.87
D1/IM = 1.32; IM = 6.60(mm)

| | Radius | Interval | Refractive | Abbe | Object |
|---|---|---|---|---|---|
| Surface | (mm) | (mm) | index | number | description |
| S1 | 10.050 | 0.500 | 1.593 | 67 | L1(meniscus) |
| S2 | 3.704 | 1.286 | | | |
| S3* | −3.545 | 0.619 | 1.531 | 57.08 | L2(aspheric) |
| S4* | 4.668 | 0.877 | | | |
| S5 | INF. | 0.540 | | | aperture stop 14 |
| S6* | 23.886 | 1.223 | 1.533 | 55.75 | L3(aspheric) |
| S7* | −3.717 | 0.143 | | | |
| S8 | 4.895 | 2.807 | 1.696 | 55.46 | L4(biconvex) |
| S9 | −2.670 | 0.500 | 1.986 | 16.48 | L5(meniscus) |
| S10 | −4.736 | 0.300 | | | |
| S11* | 8.944 | 1.197 | 1.666 | 20.42 | L6(aspheric) |
| S12* | 8.295 | 1.026 | | | |
| S13 | INF. | 0.21 | 1.517 | 64.17 | light filter 16 |
| S14 | INF. | 1.304 | | | |
| S15 | INF. | 0.4 | 1.517 | 64.17 | cover glass 18 |
| S16 | INF. | 0.05 | | | |
| S17 | | | | | image plane 19 |

In the above Table 3, an interval of the surface S1 is a distance between the surface S1 and the surface S2 along the optical axis 12, an interval of the surface S2 is a distance between the surface S2 and the surface S3 along the optical axis 12, and an interval of the surface S16 is a distance between the surface S16 and the image plane 19 along the optical axis 12.

Table 4 lists aspheric coefficients and conic constant of each aspheric surface of the optical lens 10b according to the second embodiment of the invention.

TABLE 4

| | S3 | S4 | S6 | S7 | S11 | S12 |
|---|---|---|---|---|---|---|
| K | 0 | 0 | 0 | 0 | 0 | 0 |
| A | 1.51E−01 | 1.97E−01 | 1.93E−02 | −4.64E−03 | −1.51E− | −4.76E− |
| | | | | | 02 | 03 |
| B | −7.91E−02 | 1.71E−02 | 5.65E−03 | 6.00E−03 | −1.49E− | −7.44E− |
| | | | | | 03 | 04 |
| C | 3.30E−02 | −1.70E−01 | −1.71E−03 | −4.68E−03 | 2.47E− | −3.10E− |
| | | | | | 06 | 04 |
| D | −9.02E−03 | 2.58E−01 | −3.16E−04 | 3.28E−03 | −1.11E− | 7.31E− |
| | | | | | 04 | 05 |
| E | 1.37E−03 | −1.51E−01 | 6.29E−04 | −1.03E−03 | 1.43E− | −6.54E− |
| | | | | | 05 | 06 |
| F | −8.85E−05 | 3.40E−02 | −1.57E−04 | 1.56E−04 | −1.81E− | 2.20E− |
| | | | | | 08 | 07 |

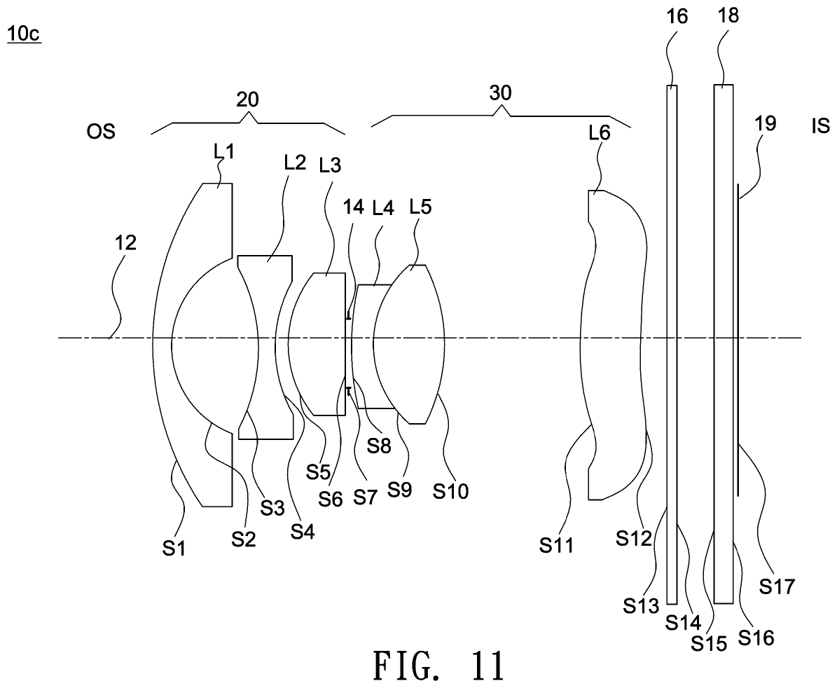

FIG. 11 shows a cross-sectional illustration of an optical lens 10c according to a third embodiment of the invention. As shown in FIG. 11, in this embodiment, the optical lens 10c includes a first lens L1, a second lens L2, a third lens L3, an aperture stop 14, a fourth lens LA, a fifth lens L5 and a sixth lens L6. The first lens L1, the second lens L2 and the third lens form a first lens group 20 (such as a front lens group) with a negative refractive power, and the fourth lens LA, the fifth lens L5 and the sixth lens L6 form a second lens group 30 (such as a rear lens group) with a positive refractive power. In this embodiment, the first lens L1, the second lens L2, the third lens L3, the fourth lens LA, the fifth lens L5 and the sixth lens L6 have negative, negative, positive, negative, positive and positive refractive powers, respectively, and the second lens L2, the third lens L3 and the sixth lens L6 are aspheric plastic lenses. In other embodiment, the aspheric plastic lens may be replaced with an aspheric glass lens. Further, the fourth lens LA and the fifth lens L5 are fit together to form a cemented doublet. In this embodiment, a diameter D1 of the surface S1 is 6.95 mm, and a diameter DL of the surface S12 is 6.13 mm. Detailed optical data and design parameters of the optical lens 10c are shown in Table 5 below.

TABLE 5
F/# = 2.0; EFL = 2.49(mm); TTL = 12.20(mm)
OAL = 10.20(mm); FOV = 164 degrees; D1/OAL = 0.68
D1/IM = 1.05; IM = 6.60(mm)

| | Radius | Interval | Refractive | Abbe | |
|---|---|---|---|---|---|
| Surface | (mm) | (mm) | index | number | Object description |
| S1 | 6.079 | 0.400 | 1.697 | 55.532 | L1(meniscus) |
| S2 | 2.000 | 1.725 | | | |
| S3* | −2.472 | 0.400 | 1.546 | 56.090 | L2(aspheric) |
| S4* | 7.051 | 0.314 | | | |
| S5* | 2.551 | 1.203 | 1.667 | 20.360 | L3(aspheric) |
| S6* | −17.172 | 0.100 | | | |
| S7 | INF. | 0.100 | | | aperture stop 14 |
| S8 | 14.709 | 0.400 | 1.946 | 17.984 | L4(meniscus) |
| S9 | 2.175 | 1.481 | 1.804 | 46.570 | L5(biconvex) |
| S10 | −3.532 | 2.813 | | | |
| S11* | 5.026 | 1.264 | 1.546 | 56.090 | L6(aspheric) |
| S12* | 11.106 | 0.616 | | | |
| S13 | INF. | 0.210 | 1.517 | 64.167 | light filter 16 |
| S14 | INF. | 0.728 | | | |
| S15 | INF. | 0.400 | 1.517 | 64.167 | cover glass 18 |
| S16 | INF. | 0.046 | | | |
| S17 | | | | | image plane 19 |

In the above Table 5, an interval of the surface S1 is a distance between the surface S1 and the surface S2 along the optical axis 12, an interval of the surface S2 is a distance between the surface S2 and the surface S3 along the optical axis 12, and an interval of the surface S16 is a distance between the surface S16 and the image plane 19 along the optical axis 12.

Table 6 lists aspheric coefficients and conic constant of each aspheric surface

of the optical lens 10c according to the third embodiment of the invention.

TABLE 6

| | S3 | S4 | S5 | S6 | S11 | S12 |
|---|---|---|---|---|---|---|
| K | −9.81 | 19.90 | 0 | 0 | 0 | 0 |
| A | 9.32E−03 | 6.47E−02 | −1.15E−02 | 1.02E−02 | −3.26E− | 3.21E− |
| | | | | | 03 | 03 |
| B | −1.16E−02 | −3.60E−02 | 9.10E−03 | 5.03E−03 | −1.49E− | −2.06E− |
| | | | | | 03 | 03 |
| C | 5.05E−03 | 1.54E−02 | −2.87E−03 | −2.42E−03 | 1.59E− | 1.44E− |
| | | | | | 04 | 04 |
| D | −1.12E−03 | −2.67E−03 | 1.11E−03 | 2.06E−03 | −1.73E− | −7.04E− |
| | | | | | 05 | 06 |
| E | 1.04E−04 | 0 | 0 | 0 | 0 | 0 |

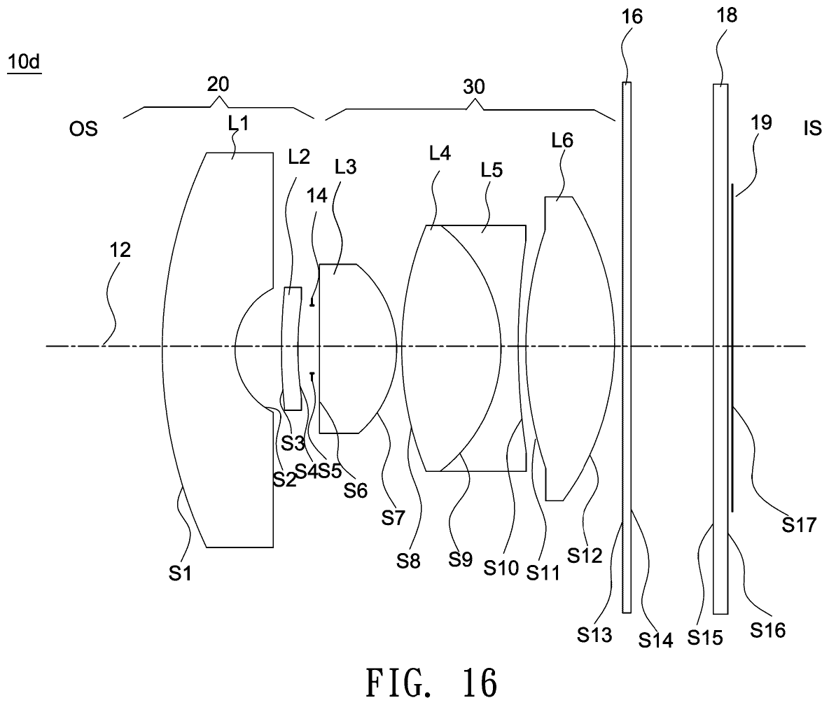

FIG. 16 shows a cross-sectional illustration of an optical lens 10d according to a fourth embodiment of the invention. As shown in FIG. 16, in this embodiment, the optical lens 10d includes a first lens L1, a second lens L2, an aperture stop 14, a third lens L3, a fourth lens LA, a fifth lens L5 and a sixth lens L6. The first lens L1 and the second lens L2 form a first lens group 20 (such as a front lens group) with a negative refractive power, and the third lens L3, the fourth lens LA, the fifth lens L5 and the sixth lens L6 form a second lens group 30 (such as a rear lens group) with a positive refractive power. In this embodiment, the first lens L1, the second lens L2, the third lens L3, the fourth lens L4, the fifth lens L5 and the sixth lens L6 have negative, positive, positive, positive, negative and positive refractive powers, respectively, and the second lens L2 and the sixth lens L6 are aspheric plastic lenses. In other embodiment, the aspheric plastic lens may be replaced with an aspheric glass lens. Further, the fourth lens L4 and the fifth lens L5 are fit together to form a cemented doublet. In this embodiment, a diameter D1 of the surface S1 is 8.10 mm, and a diameter DL of the surface S12 is 5.81 mm. Detailed optical data and design parameters of the optical lens 10d are shown in Table 7 below.

TABLE 7
F/# = 2.0; EFL = 2.26(mm); TTL = 13.00(mm)
OAL = 10.34(mm); FOV = 182 degrees; D1/OAL = 0.78
D1/IM = 1. 23; IM = 6.60(mm)

| | Radius | Interval | Refractive | Abbe | Object |
|---|---|---|---|---|---|
| Surface | (mm) | (mm) | index | number | description |
| S1 | 8.783 | 1.683 | 1.911 | 35.037 | L1(meniscus) |
| S2 | 1.445 | 1.057 | | | |
| S3* | −22.342 | 0.403 | 1.667 | 20.360 | L2(aspheric) |
| S4* | −9.961 | 0.250 | | | |
| S5 | INF. | 0.250 | | | aperture stop 14 |
| S6 | −9.186 | 1.728 | 1.749 | 35.283 | L3(meniscus) |
| S7 | −2.126 | 0.100 | | | |
| S8 | 5.873 | 2.216 | 1.550 | 75.496 | L4(biconvex) |
| S9 | −3.056 | 0.500 | 1.986 | 16.484 | L5(meniscus) |
| S10 | 24.323 | 0.100 | | | |
| S11* | 5.604 | 2.049 | 1.513 | 57.080 | L6(aspheric) |
| S12* | −4.262 | 0.148 | | | |
| S13 | INF. | 0.210 | 1.517 | 64.167 | light filter 16 |
| S14 | INF. | 1.852 | | | |
| S15 | INF. | 0.400 | 1.517 | 64.167 | cover glass 18 |
| S16 | INF. | 0.055 | | | |
| S17 | | | | | image plane 19 |

In the above Table 7, an interval of the surface S1 is a distance between the surface S1 and the surface S2 along the optical axis 12, an interval of the surface S2 is a distance between the surface S2 and the surface S3 along the optical axis 12, and an interval of the surface S16 is a distance between the surface S16 and the image plane 19 along the optical axis 12. In this embodiment, the cemented lens of the optical lens 10d includes a lens having an Abbe number of smaller than 20.

Table 8 lists aspheric coefficients and conic constant of each aspheric surface of the optical lens 10d according to the fourth embodiment of the invention.

TABLE 8

| | S3 | S4 | S11 | S12 |
|---|---|---|---|---|
| K | 0 | 0 | 0 | 0 |
| A | 9.29E−03 | 3.42E−02 | −6.46E−03 | 3.52E−03 |
| B | 4.81E−02 | 9.62E−02 | 2.96E−03 | 2.36E−03 |
| C | −1.03E−01 | −2.51E−01 | −1.12E−03 | −6.86E−04 |
| D | 1.39E−01 | 3.96E−01 | 2.45E−04 | 1.13E−04 |
| E | −9.09E−02 | −2.97E−01 | −2.76E−05 | −9.59E−06 |
| F | 2.27E−02 | 9.02E−02 | 1.15E−06 | 2.79E−07 |

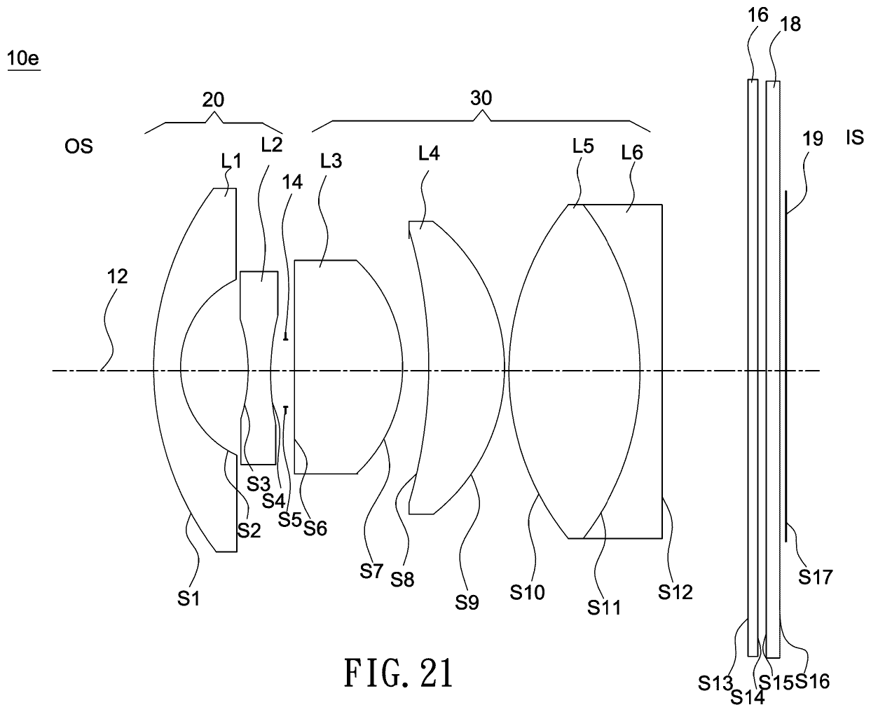

FIG. 21 shows a cross-sectional illustration of an optical lens 10e according to a fifth embodiment of the invention. As shown in FIG. 21, in this embodiment, the optical lens 10e includes a first lens L1, a second lens L2, an aperture stop 14, a third lens L3, a fourth lens LA, a fifth lens L5 and a sixth lens L6. The first lens L1 and the second lens L2 form a first lens group 20 (such as a front lens group) with a negative refractive power, and the third lens L3, the fourth lens L4, the fifth lens L5 and the sixth lens L6 form a second lens group 30 (such as a rear lens group) with a positive refractive power. In this embodiment, the first lens L1, the second lens L2, the third lens L3, the fourth lens LA, the fifth lens L5 and the sixth lens L6 have negative, negative, positive, positive, positive and negative refractive powers, respectively, and the second lens L2 and the fourth lens LA are aspheric plastic lenses. In other embodiment, the aspheric plastic lens may be replaced with an aspheric glass lens. Further, the fifth lens L5 and the sixth lens L6 are fit together to form a cemented doublet. In this embodiment, a diameter D1 of the surface S1 is 7.08 mm, and a diameter DL of the surface S12 is 5.99 mm. Detailed optical data and design parameters of the optical lens 10e are shown in Table 9 below.

TABLE 9
F/# = 2.0; EFL = 2.30(mm); TTL = 13.00(mm)
OAL = 10.47(mm); FOV = 182 degrees; D1/OAL = 0.68
D1/IM = 1.07; IM = 6.60(mm)

| | Radius | Interval | Refractive | Abbe | Object |
|---|---|---|---|---|---|
| Surface | (mm) | (mm) | index | number | description |
| S1 | 5.343 | 0.567 | 1.697 | 55.460 | L1(meniscus) |
| S2 | 1.800 | 1.225 | | | |
| S3* | −5.095 | 0.629 | 1.667 | 20.360 | L2(aspheric) |
| S4* | −16.447 | 0.355 | | | |
| S5 | INF. | 0.073 | | | aperture stop 14 |
| S6 | −19.786 | 2.238 | 1.618 | 63.396 | L3(meniscus) |
| S7 | −2.640 | 0.572 | | | |
| S8* | −7.276 | 1.574 | 1.533 | 55.750 | L4(aspheric) |
| S9* | −2.960 | 0.050 | | | |
| S10 | 4.785 | 2.685 | 1.550 | 75.496 | L5(biconvex) |
| S11 | −4.785 | 0.500 | 2.104 | 17.018 | L6(meniscus) |
| S12 | INF. | 1.873 | | | |
| S13 | INF. | 0.210 | 1.517 | 64.167 | light filter 16 |
| S14 | INF. | 0.046 | | | |
| S15 | INF. | 0.400 | 1.517 | 64.167 | cover glass 18 |
| S16 | INF. | 0.004 | | | |
| S17 | | | | | image plane 19 |

In the above Table 9, an interval of the surface S1 is a distance between the surface S1 and the surface S2 along the optical axis 12, an interval of the surface S2 is a distance between the surface S2 and the surface S3 along the optical axis 12, and an interval of the surface S16 is a distance between the surface S16 and the image plane 19 along the optical axis 12. In this embodiment, the optical lens 10e includes at least one plastic lens having an Abbe number of greater than 50.

Table 10 lists aspheric coefficients and conic constant of each aspheric surface of the optical lens 10e according to the fifth embodiment of the invention.

TABLE 10

| | S3 | S4 | S8 | S9 |
|---|---|---|---|---|
| K | 0 | 0 | 0 | −4.19513 |
| A | 3.85E−02 | 6.49E−02 | −1.65E−03 | −1.78E−02 |
| B | −6.97E−03 | −1.52E−02 | 3.46E−04 | 2.16E−03 |
| C | 1.48E−03 | 1.17E−02 | −3.91E−05 | −2.76E−04 |
| D | −1.52E−04 | 0.00E+00 | 7.59E−06 | 1.78E−05 |

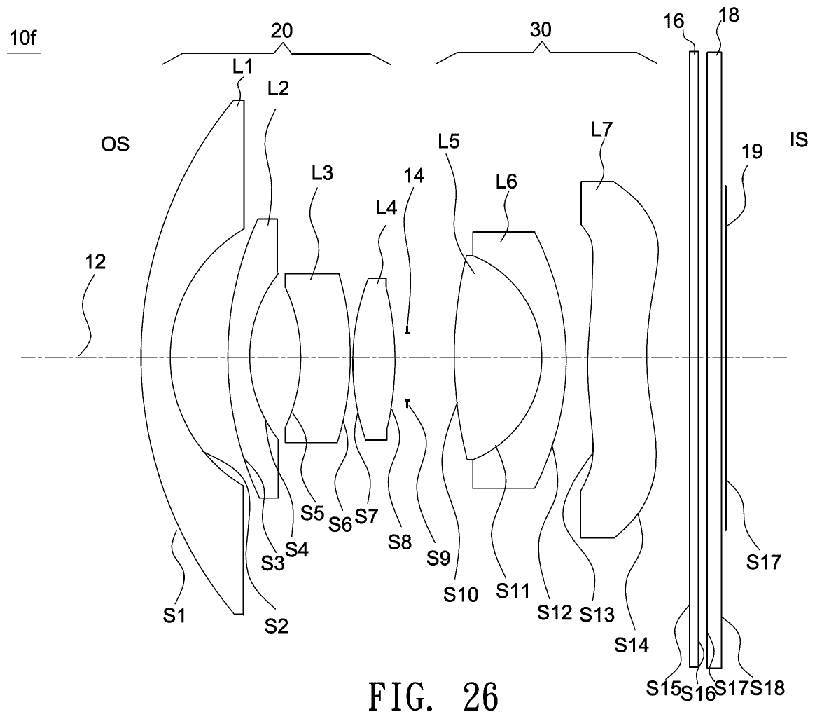

FIG. 26 shows a cross-sectional illustration of an optical lens 10f according to a sixth embodiment of the invention. As shown in FIG. 26, in this embodiment, the optical lens 10f includes a first lens L1, a second lens L2, a third lens L3, a fourth lens LA, an aperture stop 14, a fifth lens L5, a sixth lens L6 and a seventh lens L7. The first lens L1, the second lens L2, the third lens L3 and the fourth lens LA form a first lens group 20 (such as a front lens group) with a negative refractive power, and the fifth lens L5, the sixth lens L6 and the seventh lens L7 form a second lens group 30 (such as a rear lens group) with a positive refractive power. In this embodiment, the first lens L1, the second lens L2, the third lens L3, the fourth lens L4, the fifth lens L, the sixth lens L6 and the seventh lens L7 have negative, negative, negative, positive, positive, negative and negative refractive powers, respectively. The second lens L2 and the seventh lens L7 are aspheric plastic lenses, and the fourth lens L4 is a glass molding lens. In other embodiment, the aspheric plastic lens may be replaced with an aspheric glass lens. Further, the fifth lens L5 and the sixth lens L6 are fit together to form a cemented doublet. In this embodiment, a diameter D1 of the surface S1 is 9.15 mm, and a diameter DL of the surface S14 is 5.97 mm. Detailed optical data and design parameters of the optical lens 10f are shown in Table 11 below.

TABLE 11
F/# = 2.0; EFL = 1.94(mm); TTL = 12.21(mm)
OAL = 10.59(mm); FOV = 212 degrees; D1/OAL = 0.86
D1/IM = 1.48; IM = 6.18(mm)

| | Radius | Interval | Refractive | Abbe | |
|---|---|---|---|---|---|
| Surface | (mm) | (mm) | index | number | Object description |
| S1 | 6.428 | 0.606 | 1.883 | 40.765 | L1(meniscus) |
| S2 | 2.435 | 1.201 | | | |
| S3* | 8.833 | 0.500 | 1.5329 | 55.75 | L2(aspheric) |
| S4* | 2.899 | 1.001 | | | |
| S5 | −2.769 | 1.052 | 1.9229 | 20.880 | L3(meniscus) |
| S6 | −5.220 | 0.050 | | | |
| 57* | 3.738 | 0.820 | 1.8048 | 40.73 | L4(molding glass) |
| S8* | −5.915 | 0.050 | | | |
| S9 | INF. | 1.255 | | | aperture stop 14 |
| S10 | 6.921 | 1.852 | 1.6968 | 55.532 | L5(biconvex) |
| S11 | −1.842 | 0.508 | 2.1041 | 17.018 | L6(meniscus) |
| S12 | −4.099 | 0.433 | | | |
| S13* | 5.472 | 1.266 | 1.5329 | 55.75 | L7(aspheric) |
| S14* | 4.870 | 0.660 | | | |
| S15 | INF. | 0.21 | 1.517 | 64.167 | light filter 16 |
| S16 | INF. | 0.2 | | | |
| S17 | INF. | 0.4 | 1.517 | 64.167 | cover glass 18 |
| S18 | INF. | 0.12 | | | |
| S19 | | | | | image plane 19 |

In the above Table 11, an interval of the surface S1 is a distance between the surface S1 and the surface S2 along the optical axis 12, an interval of the surface S2 is a distance between the surface S2 and the surface S3 along the optical axis 12, and an interval of the surface S18 is a distance between the surface S18 and the image plane 19 along the optical axis 12. In this embodiment, the optical lens 10f includes at least two lenses each having an Abbe number of greater than 55.

Table 12 lists aspheric coefficients and conic constant of each aspheric surface of the optical lens 10f according to the sixth embodiment of the invention.

TABLE 12

| | S3 | S4 | S7 | S8 | S13 | S14 |
|---|---|---|---|---|---|---|
| K | 1.18E+ | 1.93E+ | 1.56E−01 | −5.66E+00 | 3.18E+00 | −1.44E+00 |
| | 01 | 00 | | | | |
| A | 0 | 0 | 2.39E−04 | 3.67E−03 | −1.94E−02 | −1.06E−02 |
| B | 0 | 0 | −6.69E−04 | −7.07E−04 | −9.02E−04 | −1.54E−03 |
| C | 0 | 0 | 9.09E−04 | 1.08E−03 | −3.14E−05 | 9.88E−05 |

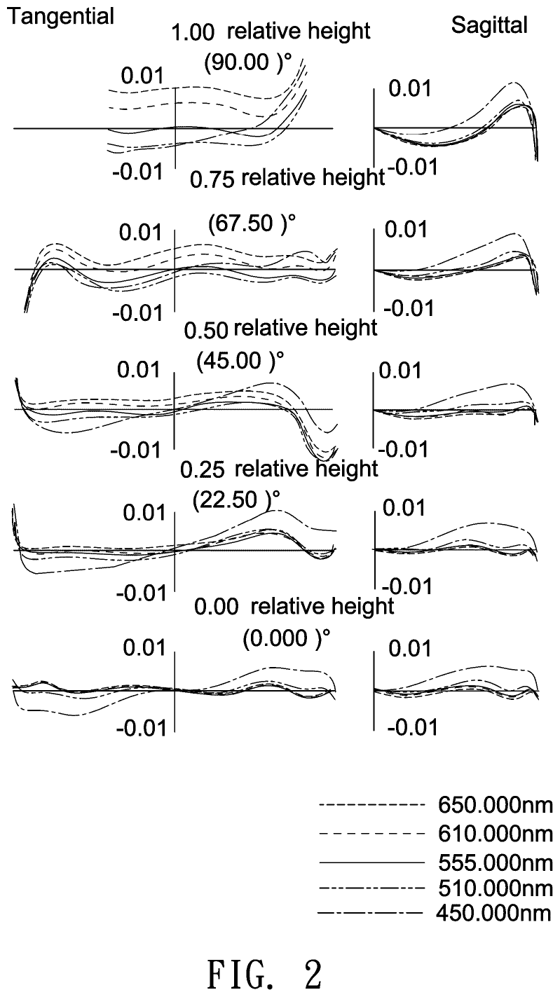

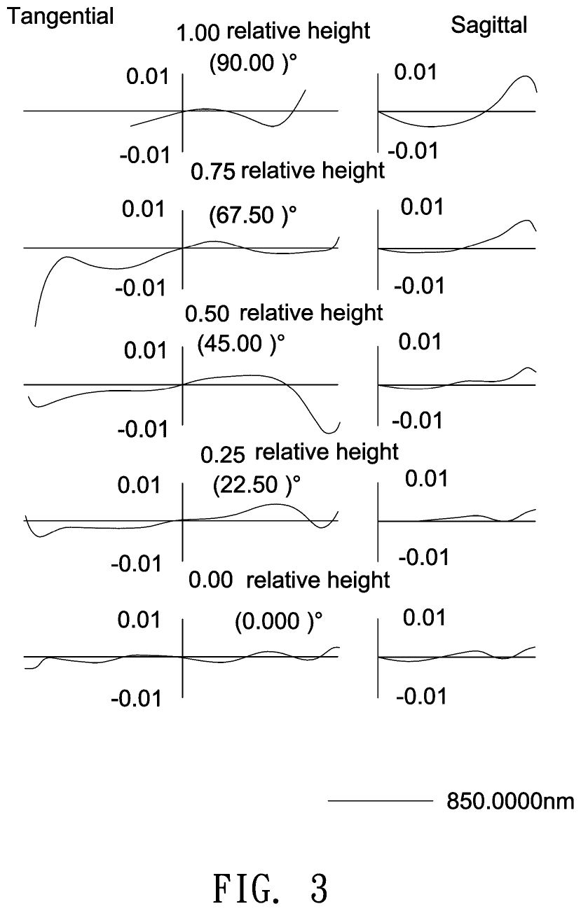

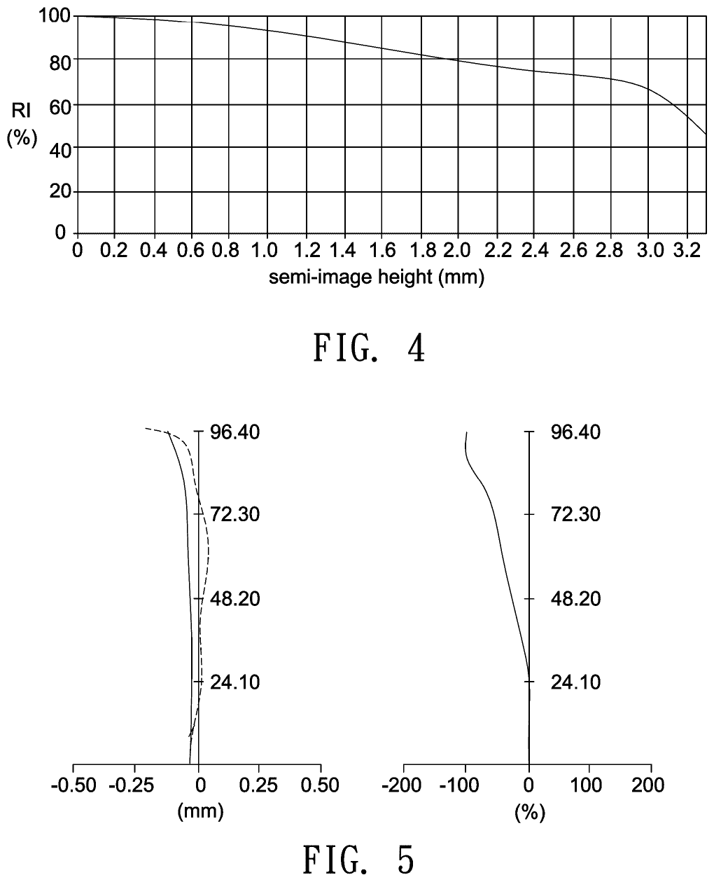

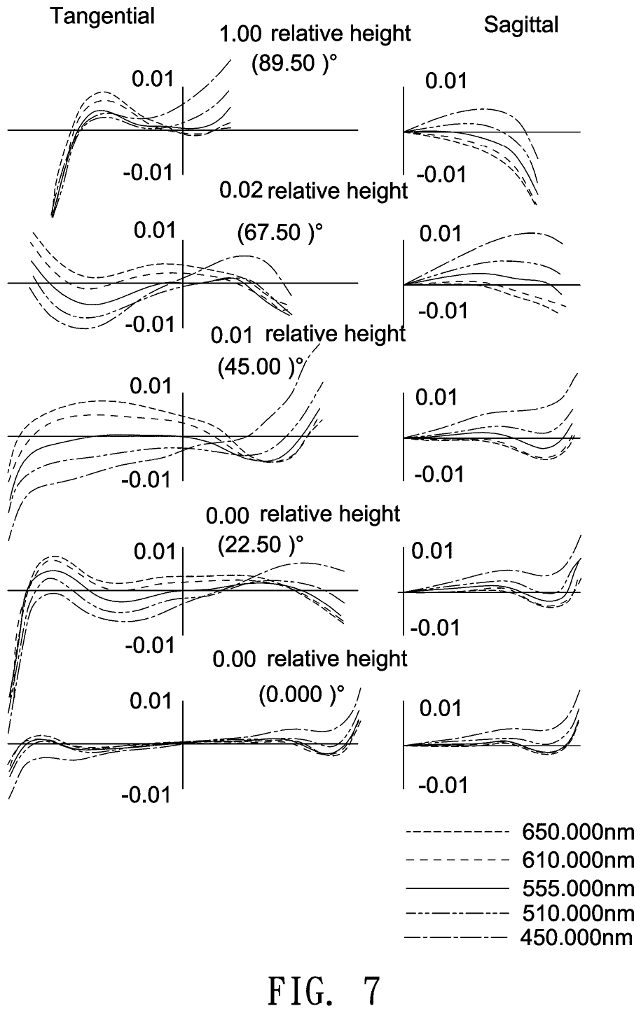

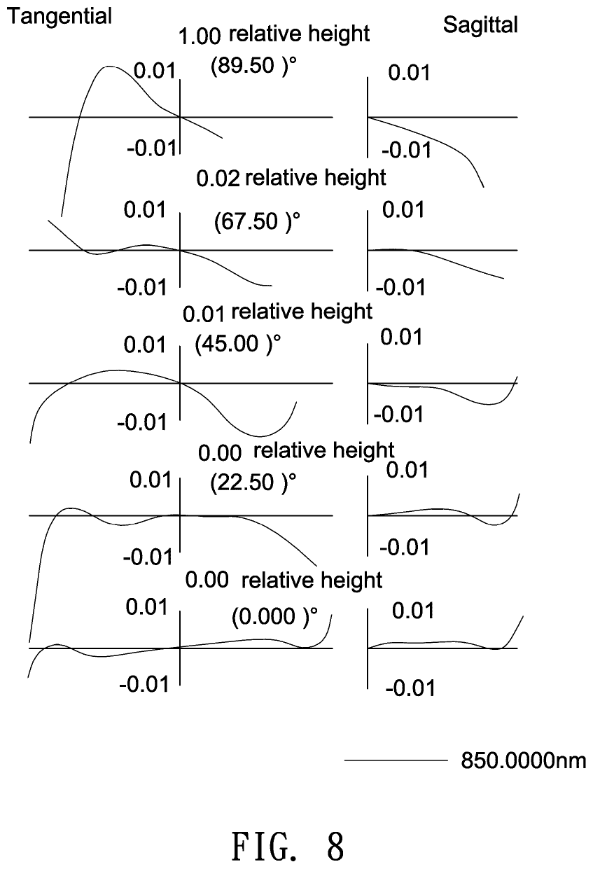

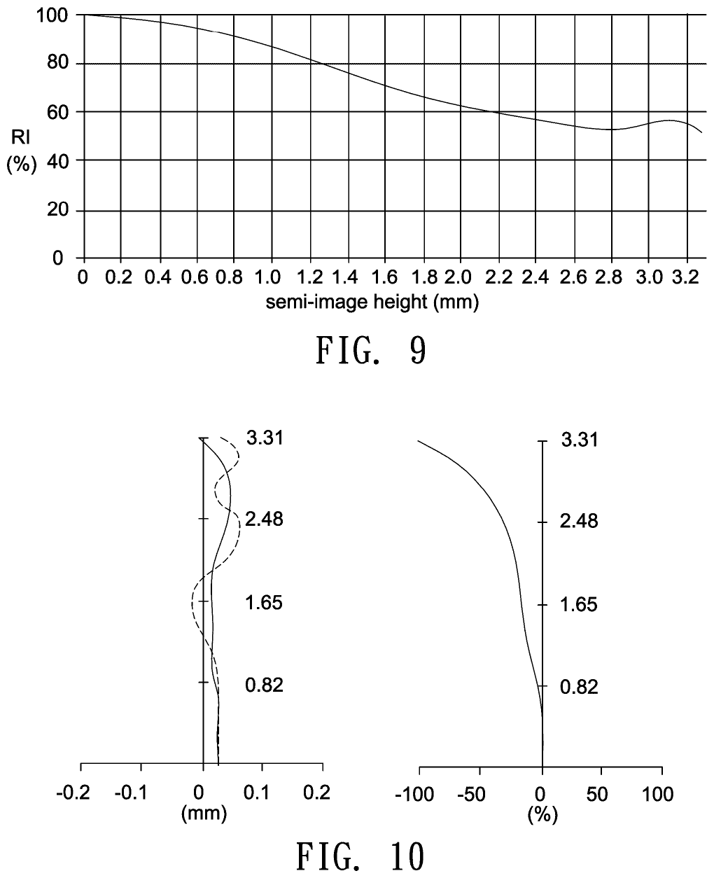

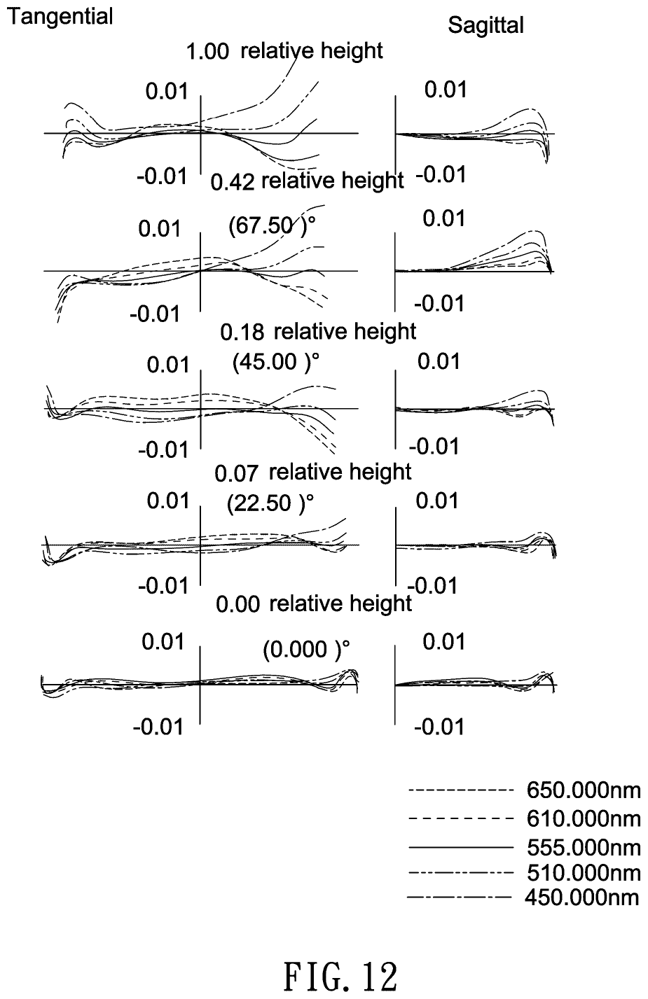

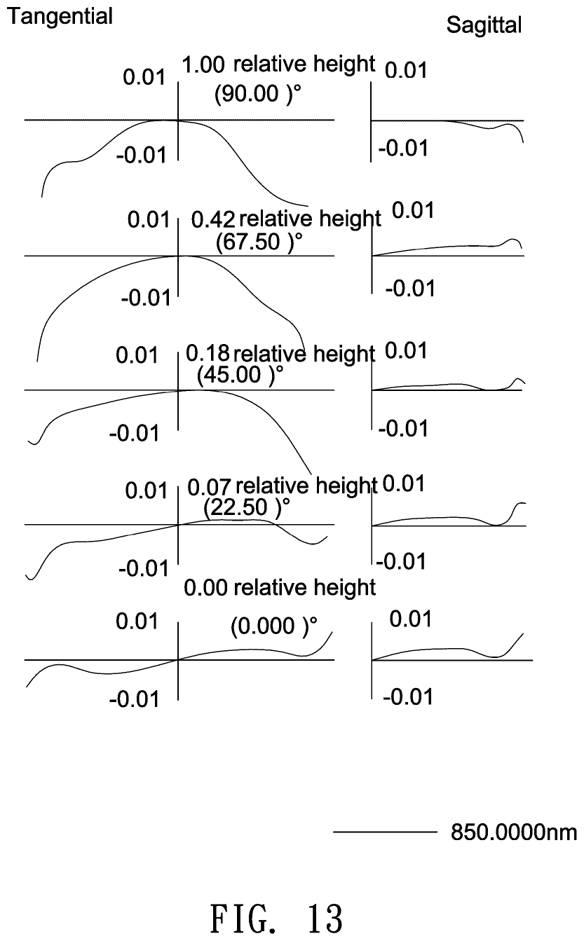

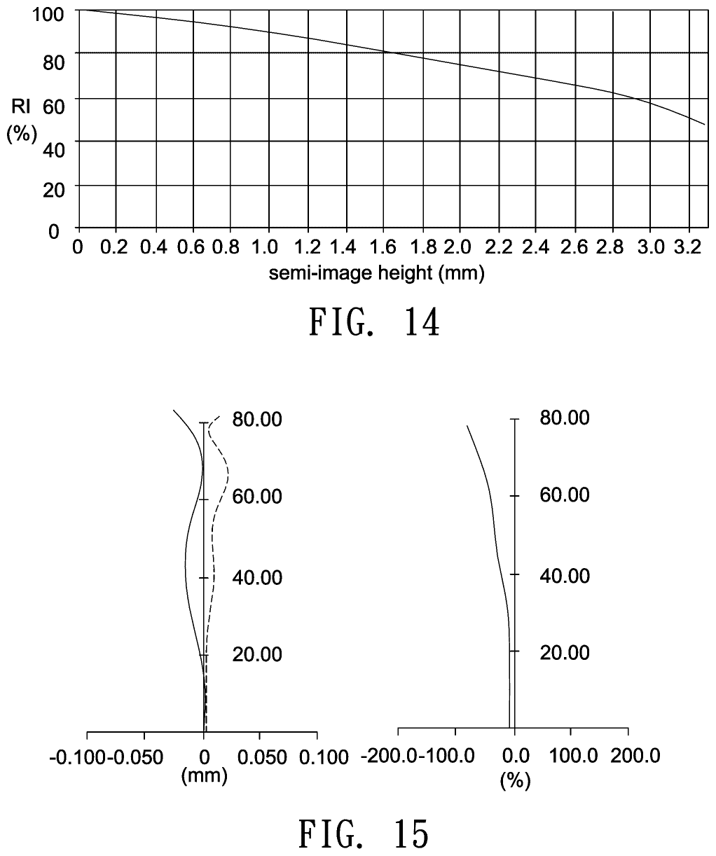

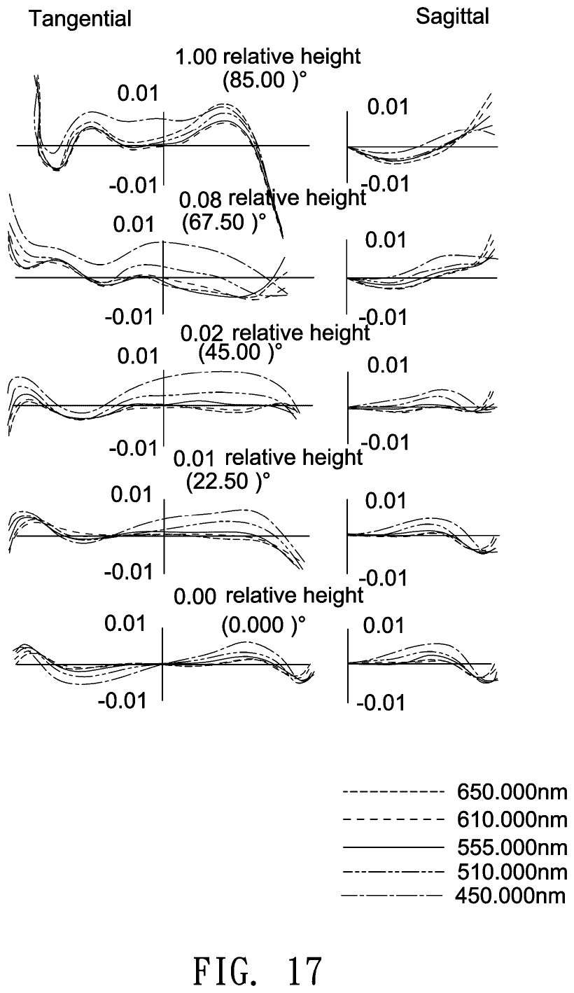

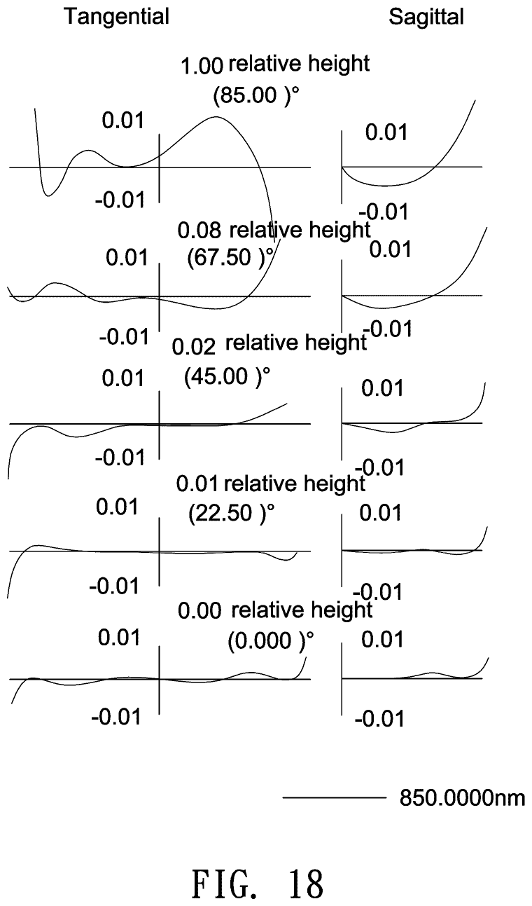

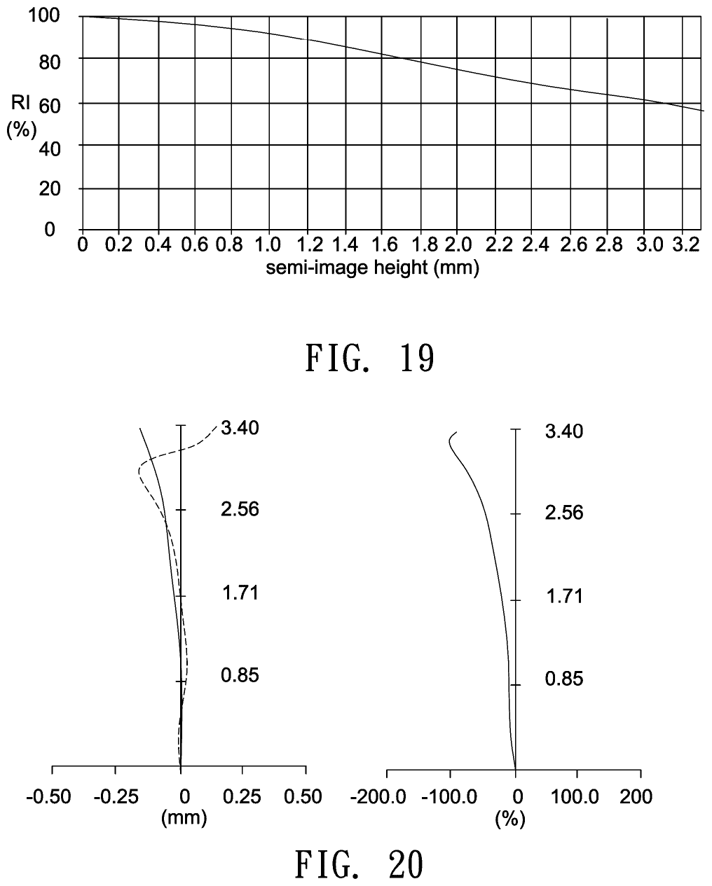

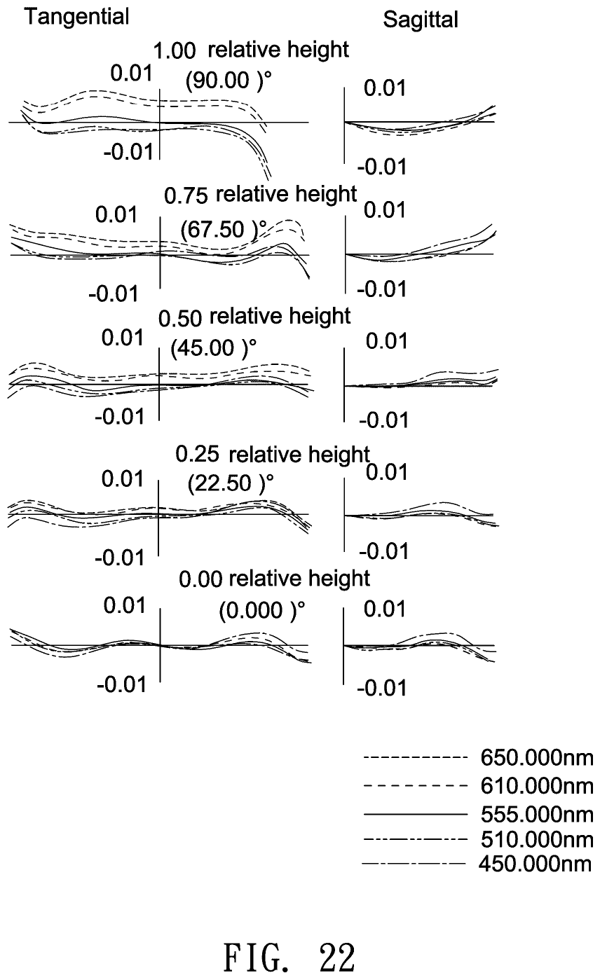

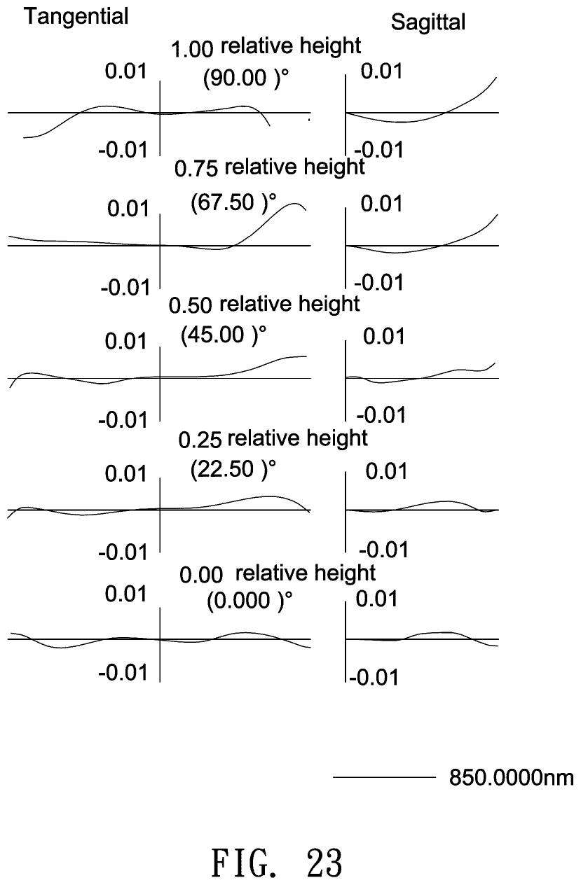

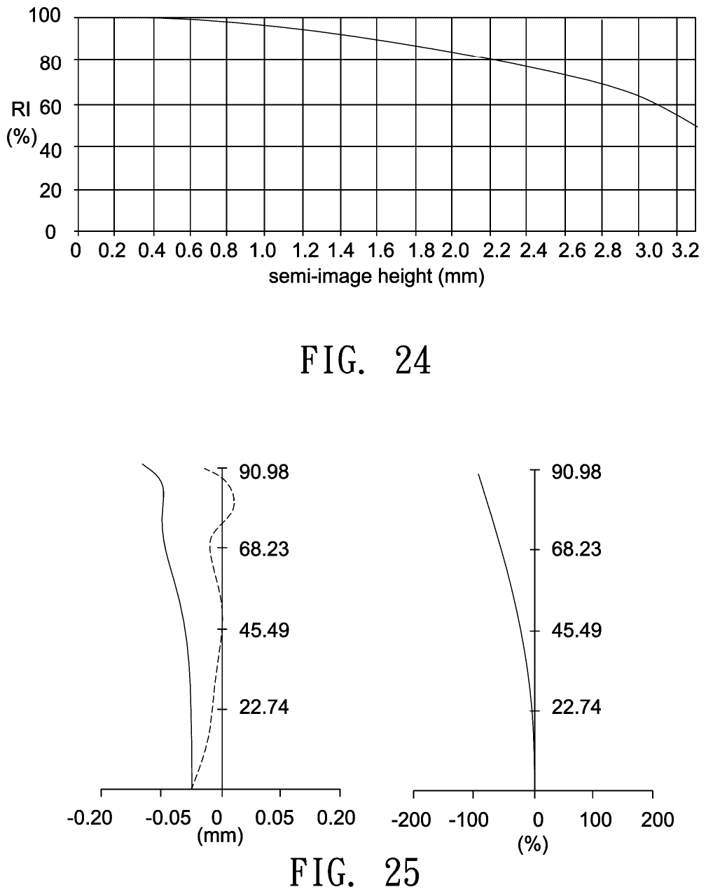

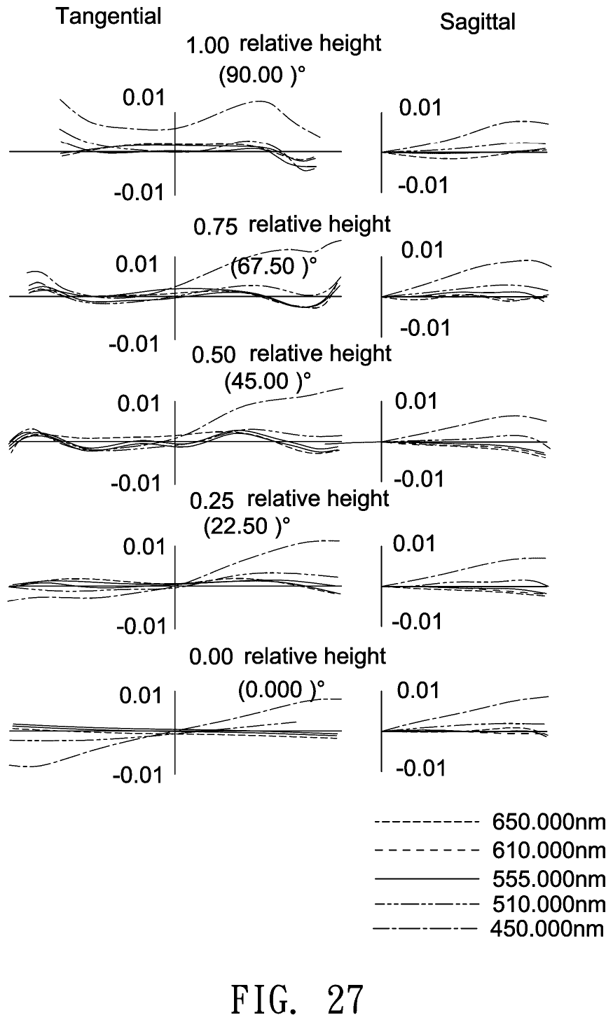

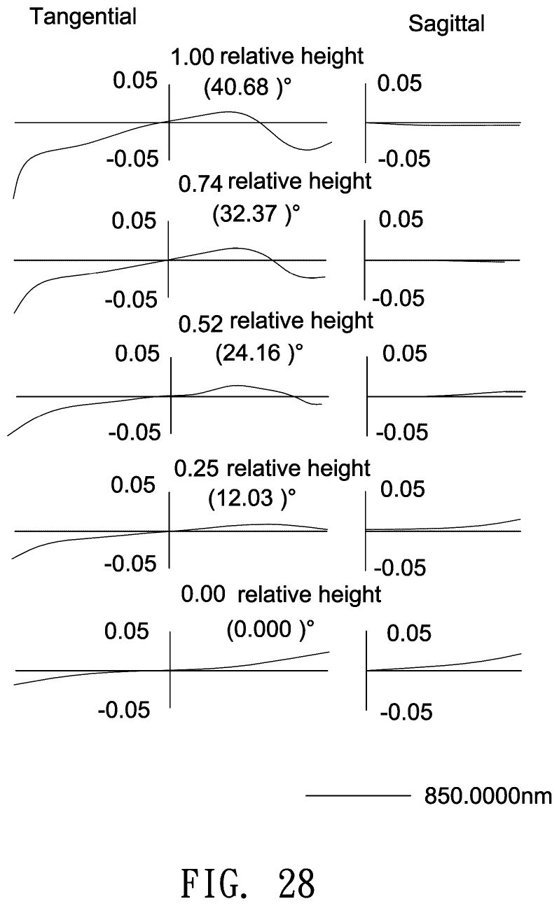

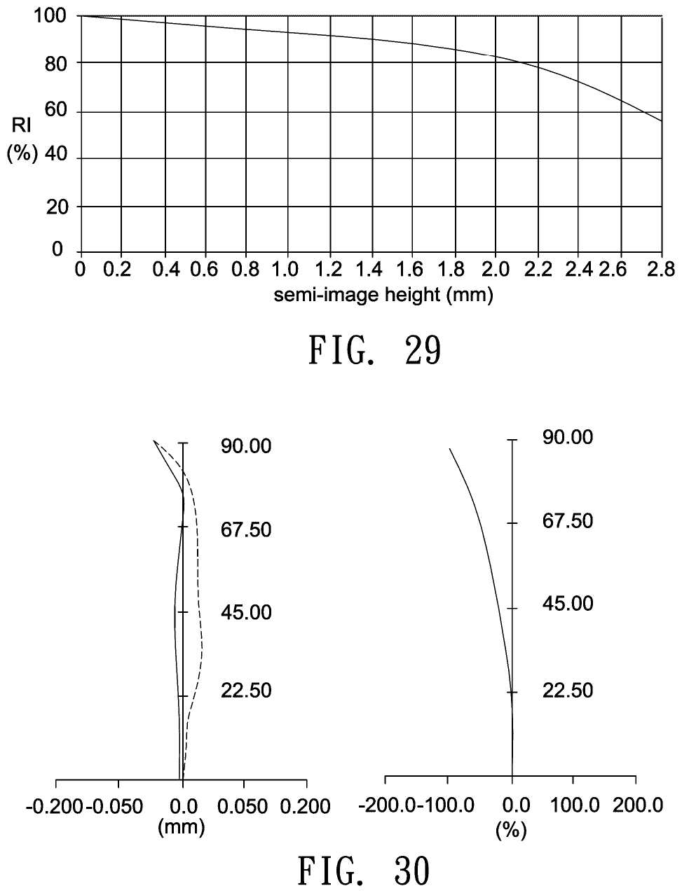

FIGS. 2-5, 7-10, 12-15, 17-20, 22-25 and 27-30 show optical simulation results of the optical lens 10a, 10b, 10c, 10d, 10e and 10f. FIGS. 2-5 respectively show a ray fan plot for visible light, a ray fan plot for infrared light, a relative illumination plot (ratios of illumination values at different height positions on an image plane to an illumination value at the optical axis), and an astigmatic field curve (left side)/a percentage distortion curve (right side) of the optical lens 10a. FIGS. 7-10 respectively show a ray fan plot for visible light, a ray fan plot for infrared light, a relative illumination plot, and an astigmatic field curve/a percentage distortion curve of the optical lens 10b. FIGS. 12-15 respectively show a ray fan plot for visible light, a ray fan plot for infrared light, a relative illumination plot, and an astigmatic field curve/a percentage distortion curve of the optical lens 10c. FIGS. 17-20 respectively show a ray fan plot for visible light, a ray fan plot for infrared light, a relative illumination plot, and an astigmatic field curve/a percentage distortion curve of the optical lens 10d. FIGS. 22-25 respectively show a ray fan plot for visible light, a ray fan plot for infrared light, a relative illumination plot, and an astigmatic field curve/a percentage distortion curve of the optical lens 10e. FIGS. 27-30 respectively show a ray fan plot for visible light, a ray fan plot for infrared light, a relative illumination plot, and an astigmatic field curve/a percentage distortion curve of the optical lens 10f. The simulated results shown in FIGS. 2-5, 7-10, 12-15, 17-20, 22-25 and 27-30 are within permitted ranges specified by the standard, which indicates the above embodiment of the optical lens 10a-10f may achieve good imaging quality. Further, a relative illumination (RI) is greater than or equal to 40% measure at an image height (image circle diameter) of 6.6 mm on a visible-light focal plane of the optical lens.

According to the above embodiments, the optical lens that may achieve at least one of the following advantage: lower fabrication costs, wider viewing angles, lower thermal drift, high resolution, a large effective aperture, a miniaturized layout, a shorter total track length, a longer back focus, 24-hours confocal image-capturing capability and better imaging quality. Besides, according to the above embodiments, a total number of lenses with refractive powers in the optical lens is 5-7, and the overall lens length OAL, namely a distance between two outermost lens surfaces among all lenses of the optical lens measured along the optical axis, is smaller than 11 mm.

Though the embodiments of the invention and design parameters in the tables have been presented for purposes of illustration and description, they are not intended to be exhaustive or to limit the invention. Accordingly, many modifications and variations without departing from the spirit of the invention or essential characteristics thereof will be apparent to practitioners skilled in this art. For example, the number of all lenses of each lens group or optical parameters such as refractive power for each lens may be changed, or a lens without affecting the overall optical performance may be additionally provided. It is intended that the scope of the invention be defined by the claims appended hereto and their equivalents in which all terms are meant in their broadest reasonable sense unless otherwise indicated.

What is claimed is:

1. A low thermal-drift optical lens, comprising:
a first lens group and a second lens group arranged in order from a magnified side to a minified side, the first lens group comprising a first lens and a second lens, the second lens group comprising a third lens and a cemented lens, and at least one of the second lens and the third lens being an aspheric plastic lens; and
an aperture stop disposed between the second lens and the cemented lens;
wherein a lens with a refractive power of the low thermal-drift optical lens closest to the minified side has at least one inflection point, a total number of lenses with refractive powers in the low thermal-drift optical lens is less than eight, the low thermal-drift optical lens comprises at most three aspheric lenses, and, in an operating temperature range of −40° C. to 80° C., a thermal drift of the low thermal-drift optical lens relative to a focal plane at 25° C. is less than or equal to 10 um.

2. The low thermal-drift optical lens as claimed in claim 1, wherein an F-number of the low thermal-drift optical lens is smaller than or equal to 2.4.

3. The low thermal-drift optical lens as claimed in claim 1, wherein the low thermal-drift optical lens has two lenses with an Abbe number of greater than 55.

4. The low thermal-drift optical lens as claimed in claim 1, wherein a lens with a refractive power of the low thermal-drift optical lens closest to the magnified side is made of glass.

5. The low thermal-drift optical lens as claimed in claim 1, wherein the first lens and the second lens have negative refractive powers.

6. The low thermal-drift optical lens as claimed in claim 1, wherein the low thermal-drift optical lens satisfies the condition:
0.5<D1/OAL<1.1, where D1 denotes a lens diameter of the first lens, and OAL denotes a distance between two outermost lens surfaces among all lenses of the low thermal-drift optical lens measured along an optical axis.

7. The low thermal-drift optical lens as claimed in claim 1, wherein a full field of view of the low thermal-drift optical lens is greater than or equal to 150 degrees.

8. The low thermal-drift optical lens as claimed in claim 1, wherein the low thermal-drift optical lens has one plastic lens with an Abbe number of greater than 50.

9. The low thermal-drift optical lens as claimed in claim 1, wherein an overall lens length OAL of the low thermal-drift optical lens is smaller than 11 mm, a total track length TTL of the low thermal-drift optical lens is smaller than 14 mm, the overall lens length OAL is a distance between two outermost lens surfaces among all lenses of the low thermal-drift optical lens measured along an optical axis, and the total track length TTL is a distance along the optical axis between a lens surface closest to the magnified side of the low thermal-drift optical lens and an image plane.

10. The low thermal-drift optical lens as claimed in claim 1, wherein the low thermal-drift optical lens satisfies a condition D1/IM>0.9, where IM denotes an image circle diameter measured on a visible-light focal plane of the low thermal-drift optical lens, and D1 denotes a lens diameter of the first lens.

11. A low thermal-drift optical lens, comprising:
a first lens group and a second lens group arranged in order from a magnified side to a minified side, the first lens group comprising a first lens and a second lens, the second lens group comprising a third lens and a cemented lens, and at least one of the second lens and the third lens being an aspheric plastic lens; and
an aperture stop disposed between the second lens and the cemented lens;
wherein a total number of lenses with refractive powers in the low thermal-drift optical lens is less than eight, the low thermal-drift optical lens comprises at most three aspheric lenses, and the low thermal-drift optical lens satisfies the condition:
1.4<OAL/IM<1.9, where OAL denotes a distance between two outermost lens surfaces among all lenses of the low thermal-drift optical lens measured along the optical axis, and IM denotes an image circle diameter measured on a visible-light focal plane of the low thermal-drift optical lens.

12. The low thermal-drift optical lens as claimed in claim 11, wherein an F-number of the low thermal-drift optical lens is smaller than or equal to 2.4.

13. The low thermal-drift optical lens as claimed in claim 11, wherein the low thermal-drift optical lens has two lenses with an Abbe number of greater than 55.

14. The low thermal-drift optical lens as claimed in claim 11, wherein a lens with a refractive power of the low thermal-drift optical lens closest to the magnified side is made of glass.

15. The low thermal-drift optical lens as claimed in claim 11, wherein the first lens and the second lens have negative refractive powers.

16. The low thermal-drift optical lens as claimed in claim 11, wherein the low thermal-drift optical lens satisfies the condition:
0.5<D1/OAL<1.1, where D1 denotes a lens diameter of the first lens.

17. The low thermal-drift optical lens as claimed in claim 11, wherein a full field of view of the low thermal-drift optical lens is greater than or equal to 150 degrees.

18. The low thermal-drift optical lens as claimed in claim 11, wherein the low thermal-drift optical lens has one plastic lens with an Abbe number of greater than 50.

19. The low thermal-drift optical lens as claimed in claim 11, wherein the overall lens length OAL of the low thermal-drift optical lens is smaller than 11 mm, a total track length TTL of the low thermal-drift optical lens is smaller than 14 mm, and the total track length TTL is a distance along the optical axis between a lens surface closest to the magnified side of the low thermal-drift optical lens and an image plane.

20. The low thermal-drift optical lens as claimed in claim 11, wherein the low thermal-drift optical lens satisfies a condition D1/IM>0.9, where D1 denotes a lens diameter of the first lens.
